(19) United States
(12) Patent Application Publication
(10) Pub. No.: US 2026/0052105 A1
(43) Pub. Date: Feb. 19, 2026

(54) UE-Initiated QoS Flow to DRB Mapping

(71) Applicant: Apple Inc., Cupertino, CA (US)

(72) Inventors: Ralf ROSSBACH, Munich (DE); Bobby JOSE, San Diego, CA (US); Pavan NUGGEHALLI, San Carlos, CA (US); Vijay VENKATARAMAN, San Jose, CA (US)

(21) Appl. No.: 19/101,384

(22) PCT Filed: Aug. 8, 2023
(86) PCT No.: PCT/US2023/029701

§ 371 Date: Feb. 5, 2025

Related U.S. Application Data
(60) Provisional application No. 63/370,746, filed on Aug. 8, 2022.

(51) Int. Cl. H04L 47/24; H04L 69/22; H04L 69/324

(52) U.S. Cl. CPC H04L 47/24; H04L 69/22; H04L 69/324

(57) ABSTRACT

A user equipment (UE) configured to establish a protocol data unit (PDU) session including one or more quality of service (QoS) flows and multiple data radio bearers (DRB) for communications with a network, decode, from signaling received from the network, or determine an initial mapping table for a QoS flow to DRB mapping based on a network configuration of mapping parameters, determine a first QoS flow to map or remap to a new or different DRB and configure transceiver circuitry to transmit a request to the network for the first QoS flow to be mapped or remapped to the new or different DRB.

### PRIORITY/INCORPORATION BY REFERENCE

This application claims priority to U.S. Provisional Application Ser. No. 63/370,746 filed on Aug. 8, 2022, and entitled “UE-Initiated QoS Flow to DRB Mapping,” the entirety of which is incorporated herein by reference.

### BACKGROUND

A user equipment (UE) may establish a connection to at least one of a plurality of different networks or types of networks, for example a 5G New Radio (NR) radio access technology (RAT). The UE may access external data networks (DN), such as extended reality (XR) or industrial Internet of Things (IIoT) services, via the 5G NR radio access network (RAN) and 5G-Core (5GC). During operation, some services may utilize multiple parallel data flows in the uplink (UL) and/or downlink (DL). In XR, for example, there may be a video stream, an audio stream and/or other data streams in the DL and there may be a control stream, a pose stream and/or other data streams in the UL. These data streams can be associated with multiple parallel QoS flows. Some traffic may have high throughput and low latency requirements, while other traffic may have more relaxed requirements, for these data flows transmitted in parallel.

According to current specification, only the network/gNB can trigger an update of the QoS flow to DRB mapping of UL and DL traffic. However, depending on the mapping of QoS flows to logical channels, the data queues at the UE side can fill up very quickly. Delays on one or more DRBs can lead to a degradation of service and/or user experience when some packets do not arrive within latency bounds. It would be useful for a UE to influence the selection of DRB resources for traffic flows.

### SUMMARY

Some exemplary embodiments are related to an apparatus of a user equipment (UE), the apparatus having processing circuitry configured to establish a protocol data unit (PDU) session including one or more quality of service (QoS) flows and multiple data radio bearers (DRB) for communications with a network, decode, from signaling received from the network, or determine an initial mapping table for a QoS flow to DRB mapping based on a network configuration of mapping parameters, determine a first QoS flow to map or remap to a new or different DRB and configure transceiver circuitry to transmit a request to the network for the first QoS flow to be mapped or remapped to the new or different DRB.

Other exemplary embodiments are related to a processor configured to establish a protocol data unit (PDU) session including one or more quality of service (QoS) flows and multiple data radio bearers (DRB) for communications with a network, decode, from signaling received from the network, or determine an initial mapping table for a QoS flow to DRB mapping based on a network configuration of mapping parameters, determine a first QoS flow to map or remap to a new or different DRB and configure transceiver circuitry to transmit a request to the network for the first QoS flow to be mapped or remapped to the new or different DRB.

Still further exemplary embodiments are related to an apparatus of a base station, the apparatus having processing circuitry configured to establish a protocol data unit (PDU) session including one or more quality of service (QoS) flows and multiple data radio bearers (DRB) for communications with a user equipment (UE), indicate mapping parameters for the UE to determine an initial mapping table for a QoS flow to DRB mapping, decode, from signaling received from the UE, a request from the UE for a first QoS flow to be mapped or remapped to a new or different DRB and determine whether to honor the request and follow the mapping or remapping of the first QoS flow to the new or different DRB based on policy rules configured for the base station.

Additional exemplary embodiments are related to a processor configured to establish a protocol data unit (PDU) session including one or more quality of service (QoS) flows and multiple data radio bearers (DRB) for communications with a user equipment (UE), indicate mapping parameters for the UE to determine an initial mapping table for a QoS flow to DRB mapping, decode, from signaling received from the UE, a request from the UE for a first QoS flow to be mapped or remapped to a new or different DRB and determine whether to honor the request and follow the mapping or remapping of the first QoS flow to the new or different DRB based on policy rules configured for the base station.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary network arrangement for QoS flow and DRB mapping according to various exemplary embodiments.

FIG. 5a shows a diagram for QoS flow mapping at the SDAP layer according to various exemplary embodiments.

FIG. 5b shows a DL SDAP header according to various exemplary embodiments.

FIG. 5c shows a UL SDAP header according to various exemplary embodiments.

FIG. 5d shows a DL SDAP data PDU format with a DL SDAP header according to various exemplary embodiments.

FIG. 5e shows a UL SDAP data PDU format with a UL SDAP header according to various exemplary embodiments.

FIG. 5f shows an exemplary signaling and processing flow diagram for reflective QoS flow to DRB mapping according to various exemplary embodiments.

FIG. 5g shows an exemplary signaling and processing flow diagram for reflective QoS flow to DRB mapping for a new QoS flow according to various exemplary embodiments.

FIG. 5h shows an exemplary signaling and processing flow diagram for explicit QoS flow to DRB mapping for a new QoS flow according to various exemplary embodiments.

FIG. 6a shows a signaling and processing diagram for a QoS flow to DRB mapping or remapping using reflective QoS based on a UE-initiated request according to various exemplary embodiments.

FIG. 6b shows a signaling and processing diagram for a QoS flow to DRB mapping or remapping using explicit RRC signaling based on a UE-initiated request according to various exemplary embodiments.

FIG. 7 shows a UL SDAP control PDU with an extension header according to various exemplary embodiments.

FIG. 8 shows an exemplary signaling and processing flow diagram for UE-controlled QoS flow to DRB mapping according to various exemplary embodiments.

FIG. 9 shows a method for a UE-initiated QoS flow to DRB mapping/remapping according to various exemplary embodiments.

### DETAILED DESCRIPTION

The exemplary embodiments may be further understood with reference to the following description and the related appended drawings, wherein like elements are provided with the same reference numerals. The exemplary embodiments relate to operations for a user equipment (UE) to initiate or request a mapping or remapping of a quality of service (QoS) flow to a data radio bearer (DRB).

In some scenarios, including Internet Protocol (IP) and/or Ethernet data traffic for extended reality (XR) or industrial Internet of Things (IIoT) services, multiple QoS flows having different throughput and/or latency requirements can be transmitted in parallel on multiple DRBs. Delays on one DRB can negatively affect the user experience. In some scenarios, it may be more efficient for the UE to initiate or request a QoS flow remapping.

According to some aspects, the UE can request the network for an updated QoS flow identifier (QFI) to DRB mapping using an indication in an uplink (UL) service data adaptation protocol (SDAP) header. In other aspects, the UE can request the updated mapping using UL radio resource control (RRC) signaling. In still other aspects, the UE can send the request and assume the network will follow the updated mapping of the QoS flows included therein, e.g., a UE-controlled remapping. The techniques described herein further relate to reflective QoS mapping and explicit QoS mapping via RRC on both the DL and the UL.

The exemplary embodiments relate to enhancements for extended Reality (XR) or industrial Internet of Things (IIoT) applications. Those skilled in the art will understand that XR is an umbrella term for different types of realities and may generally refer to real-and-virtual combined environments and associated human-machine interactions generated by computer technology and wearables. To provide some examples, the term XR may encompass augmented reality (AR), mixed reality (MR) and virtual reality (VR). However, any reference to XR being specific to a particular use case or type of traffic is merely provided for illustrative purposes. Those skilled in the art will understand that IIoT relates to industrial applications including, for example, production, robotics, and/or medical, that can be implemented in time sensitive networks (TSN) with low latency requirements. Although some of the exemplary embodiments are described with regard to enhancements for XR and/or IIoT services, the exemplary embodiments are not limited to XR or IIoT services and may apply to any type of NR traffic that may be subject to processing requirements imposed by an external application.

During operation, some services may utilize multiple data flows in the uplink (UL) and/or downlink (DL). From a physical channel perspective, there may be different control channels and shared channels for each stream or multiple streams may share a control channel and/or shared channel. In some configurations, each stream may have different quality of service (QoS) requirements (e.g., block error rate (BLER), latency requirements, etc.). Additionally, a UE may transmit data on the UL that is forwarded to another UE on the DL or transmit data directly to another UE via a sidelink (SL).

In addition, the exemplary embodiments are described with regard to a UE. Those skilled in the art will understand that the UE may be any type of electronic component that is configured to communicate via a network, e.g., mobile phones, tablet computers, desktop computers, smartphones, phablets, embedded devices, wearables, Internet of Things (IoT) devices, etc. With regard to XR, in some configurations, the UE may be paired with a wearable device (e.g., a head mounted display (HMD), AR glasses, etc.). In this type of configuration, the UE may communicate directly with the network and then relay data to the wearable device which presents the XR content to the user (e.g., AR, VR, MR, etc.). In other configurations, the UE may be a wearable device that communicates directly with the network and presents the XR content to the user. Therefore, the UE as described herein is used to represent any electronic component that directly communicates with the network.

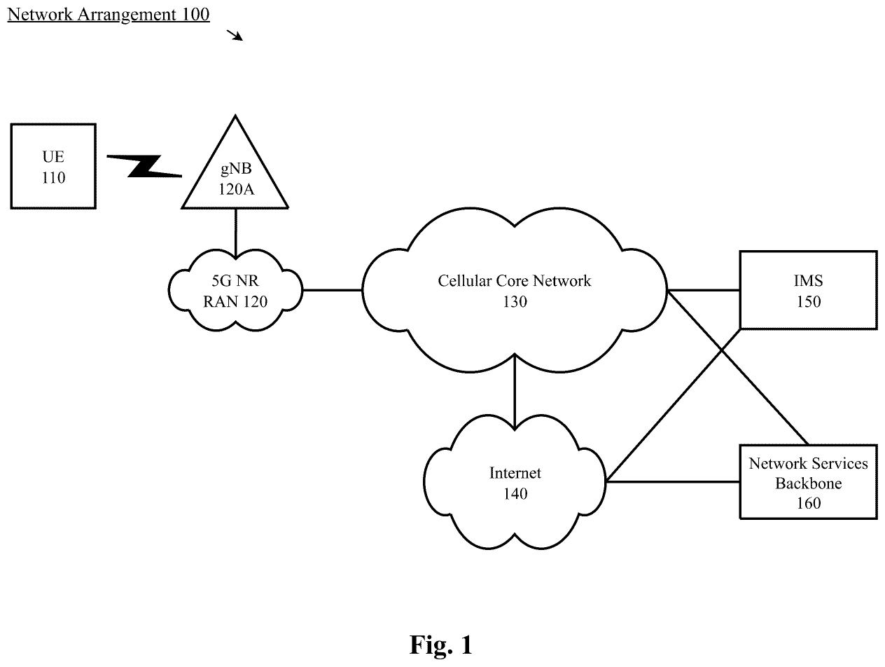

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables (e.g., HMD, AR glasses, etc.), Internet of Things (IoT) devices, industrial IoT (IIoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a WLAN, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

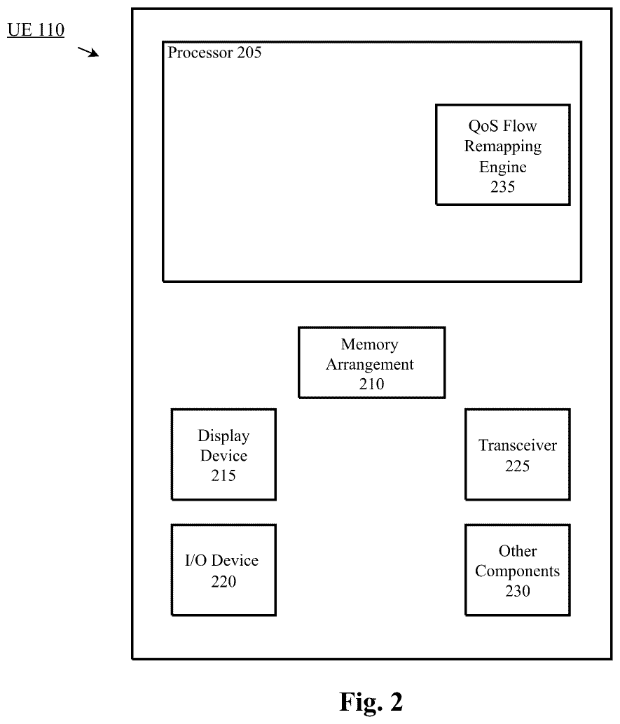

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a QoS flow remapping engine 235 for performing various operations related to initiating a QoS flow to DRB remapping at the access stratum (AS) level, to be described in detail below.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies). The transceiver 225 may encompass an advanced receiver (e.g., E-MMSE-RC, R-ML, etc.) for MU-MIMO. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

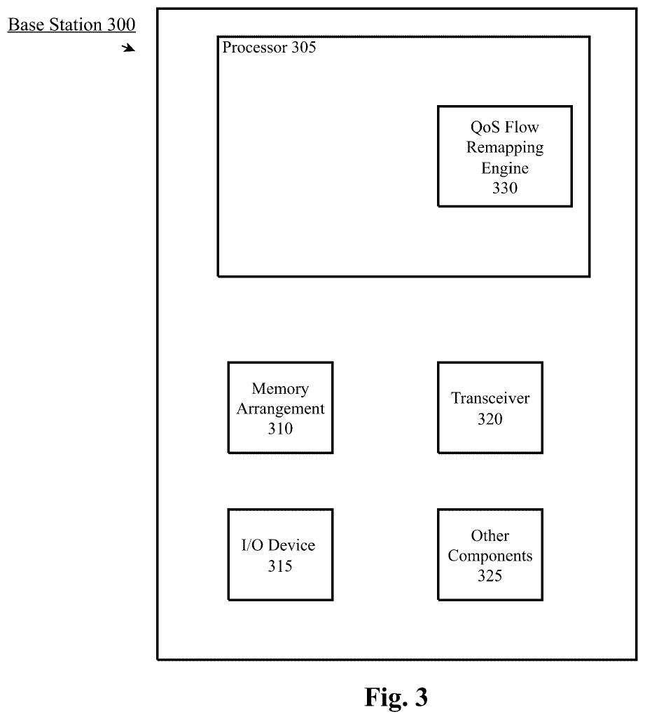

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a QoS flow remapping engine 330 for performing various operations related to receiving a UE-initiated QoS flow to DRB remapping request and configuring/reconfiguring the UE with an updated QoS flow to DRB mapping at the access stratum (AS) level, to be described in detail below.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

In XR (and/or cloud gaming), application traffic on the downlink (DL) may comprise encoded video or scene information. Some XR applications may require a minimum granularity of application data to be available on the client side prior to performing the next level of processing. For example, in some configurations, client processing of application data may begin only once all bits of a video frame, or a certain percentage of those bits, are available to the client device. This application data may be, for example, a video frame that may be packetized into multiple IP payloads.

This minimum granularity of information required by a given application may be referred to as an “Application Data Unit” (ADU) or PDU set. XR (and/or cloud gaming) traffic comprises bursts of traffic that can carry one or more ADUs or PDU set. Each ADU or PDU set can comprise a number of PDUs or packets, e.g., 3 or 4 IP packets. The number of packets included in an ADU or PDU set may vary within a given application and across different applications depending on the data included therein. Thus, depending on the XR application, the size of the ADUs or PDU sets may be different. It should be understood that three or four IP packets is an example and the ADU or PDU set may include any number of IP packets, ethernet packets, or other kind of packet. The packets belonging to a particular ADU or PDU set may be transmitted across multiple data streams or in the same data stream. It is noted that the exemplary embodiments are not limited to XR or IIoT services and provide enhancements generic to the 5G user plane that can be applied to any type of service. It is further noted that the exemplary embodiments are not limited to IP traffic and may be applied for any type of packet including at least Ethernet, see TS 23.501, clause 5.7.6.

The 5G-RAN and 5GC ensure quality of service (QoS) by mapping packets to appropriate QoS flows and DRBs. The entities involved in packet handling of downlink (DL) data and uplink (UL) data for a UE generally include a user plane function (UPF) of the 5GC (e.g., an instance of the UPF), a base station (gNB) and the UE. Each of these entities identifies certain information about the packet prior to processing the packet. Some access stratum (AS) packet processing functions are performed at the service data adaptation protocol (SDAP) layer of the gNB/UE.

The UPF acts as an external PDU session point of interconnect to a DN and may perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform Uplink Traffic verification (e.g., SDF to QoS flow mapping), transport level packet marking in the uplink and downlink, and perform downlink packet buffering and downlink data notification triggering.

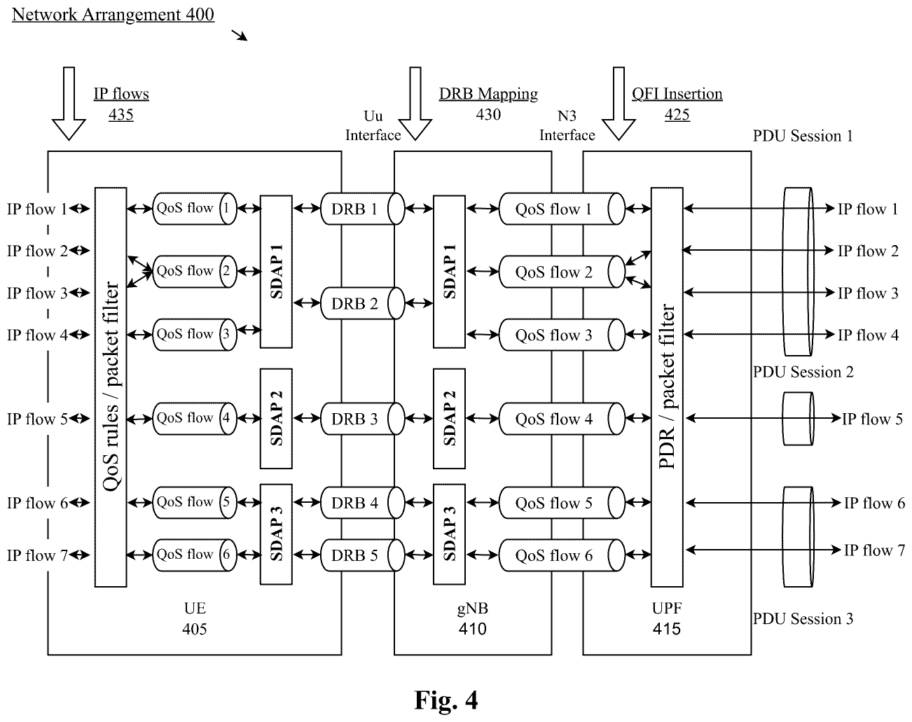

FIG. 4 shows an exemplary network arrangement 400 for QoS flow and DRB mapping according to various exemplary embodiments. The network arrangement 400 includes a UE 405, a gNB 410 and a UPF 415. The QoS flow and DRB mapping is described herein for a downlink traffic flow comprising multiple data streams. However, the person skilled in the art understands that a similar and complementary process may also occur on the uplink.

In a first step for DL packet handling, at the non-access stratum (NAS) level, the UPF 415 receives IP data flows 420 from a data network (DN) via one or more PDU sessions. Each PDU session may correspond to a connection with a different data network (DN) and/or the Internet. In the example of FIG. 4, the UPF 415 receives a first IP flow (IP1), a second IP flow (IP2), a third IP flow (IP3) and a fourth IP flow (IP4) via a first set of PDU sessions (PDU 1). The first set of PDU sessions may comprise, for example, Internet PDU sessions, and the IP flows 1-4 may correspond to video streams, e.g., YouTube or Skype video streams. The UPF 415 receives a fifth IP flow (IP5) via a second set of PDU sessions (PDU 2), e.g., a streaming service PDU session, and IP5 may correspond to a video stream, e.g., a Netflix stream. The UPF 415 receives a sixth IP flow (IP6) and a seventh IP flow (IP7) via a third set of PDU sessions (PDU 3). The third set of PDU sessions may comprise, for example, IMS PDU sessions, wherein IP6 corresponds to a voice stream and IP7 corresponds to a video stream. It should be understood that each of these streams is only exemplary and the streams are not limited to any specific type of data stream.

The UPF 415 processes the received packets using a Service Data Flow (SDF) traffic filter template, e.g., a packet filter. The UPF 415 maps the IP flows to QoS flows based on packet detection rules (PDR) configured by the 5GC. The UPF 415 associates a QoS flow identifier (QFI) with the IP flows by inserting a QFI into the packets (step 425) and transmitting the packets to the gNB 410 over the N3 interface via e.g., a GTP-U tunnel. In the example of FIG. 4, IP1 maps to a first QoS flow (QFI=1), IP2 and IP3 map to a second QoS flow (QFI=2), IP4 maps to a third QoS flow (QFI=3), IP5 maps to a fourth QoS flow (QFI=4), IP6 maps to a fifth QoS flow (QFI=5), and IP7 maps to a sixth QoS flow (QFI=6).

In a second step, at the AS level, the gNB 410 receives the QoS flows from the UPF 415 via N3 and maps the QoS flows to DRBs via one or more instances of the SDAP layer based on QoS profiles/mapping configured by the network. The DRB defines the packet treatment on the radio interface (Uu) and serves packets with the same packet forwarding treatment. The QoS flow to DRB mapping by the gNB 410 is based on QFI and the associated QoS profiles (i.e., QoS parameters and QoS characteristics) configured by the 5GC. The QoS profiles for the respective QFIs are provided by the AMF to the 5G-RAN (gNB 410).

Separate DRBs may be established for QoS flows requiring different packet forwarding treatment, or several QoS flows belonging to the same PDU session can be multiplexed in the same DRB. The gNB 410 associates a DRB ID with the QoS flows and transmits the packets to the UE 405 over the air interface (Uu). In the example of FIG. 4, the first QoS flow maps to a first DRB (DRB=1), the second and third QoS flows map to a second DRB (DRB=2), the fourth QoS flow maps to a third DRB (DRB=3), the fifth QoS flow maps to a fourth DRB (DRB=4), and the sixth QoS flow maps to a fifth DRB (DRB=5). Several QoS flows belonging to the same PDU session can be mapped to the same DRB, while QoS flows belonging to different PDU sessions cannot be mapped to the same DRB.

In a third step, at the UE level, the UE 405 receives the data in the DRBs over the air interface via one or more instances of the SDAP layer. The QoS flows are mapped by the 5GSM layer to IP flows according to packet filters contained in QoS rules configured by the 5GC. The PDRs at the UPF 415 and the QoS rules at the UE 405 may include similar and complementary packet filters. Thus, the original IP packets are extracted and delivered to the higher layers. It should be understood that when IP flows are generated by the UE 405 for UL transmission, the 5GSM layer similarly maps IP flows to QoS flows according to the packet filters contained in the QoS rules.

As described above, QoS flow to DRB mapping is performed at the RAN/gNB (access stratum (AS)) at the SDAP layer. Several QoS flows belonging to the same PDU session can be mapped to the same DRB, while QoS flows belonging to different PDU sessions cannot be mapped to the same DRB. The RAN can add new DRBs with corresponding QFI mappings to fulfill the QoS characteristics of a QoS Flow. The UE determines the UL data QoS binding either via explicit RRC signaling or via reflective QoS (RQoS) based on a DL data QoS marking, to be described in greater detail below.

To be described in detail below, the exemplary embodiments relate to extensions of the QoS flow to DRB mapping step described above. The exemplary techniques may enable more dynamic QoS adaptation and related user plane enhancements. Some techniques may also facilitate better treatment of groups of packets characterized by a PDU set or in ADU-based QoS.

According to existing techniques, a mapping between a QoS flow and a DRB is decided by the gNB and can comprise explicit signaling or reflective QoS (RQoS). In an explicit mapping technique, the gNB uses RRC signaling, e.g., explicit QoS signaling, to indicate, for the UL traffic of the UE, which QoS flow is sent over which DRB. In a reflective QoS technique, the gNB includes an indication, e.g., RDI bit, in a DL packet that triggers the UE to update its UL mapping table based on the QFI and DRB for the DL packet. The UE monitors DL traffic to determine on which DRB a QoS flow was received and, after the RDI bit and the QFI/PQFI is received and the UE updates its mapping table, the UE sends UL traffic over the same DRB and with the same QoS flow. These techniques make it possible for the network to send DL data for a single QoS flow in different DRBs. This provides a useful tool for the gNB to provide different packet forwarding or priority treatment for some packets with a single QoS flow.

One SDAP entity is established at the UE and the gNB for each individual PDU session, as described above. The SDAP layer performs the mapping between a QoS flow and a DRB. When explicit RRC signaling is used, the UE SDAP is configured with QFI-to-DRB mapping rules to indicate which QoS flow is sent over which DRB, including DL and UL mapping rules. When reflective UL mapping is used, the UE SDAP updates its UL mapping tables based on the QFI of received DL packets, to be described below. If no mapping rule is defined, the UE uses a default DRB for a QoS flow. The SDAP of the transmitting entity (UE or gNB) can add an SDAP header to mark QFI in UL or DL data packets, for various reasons to be explained below.

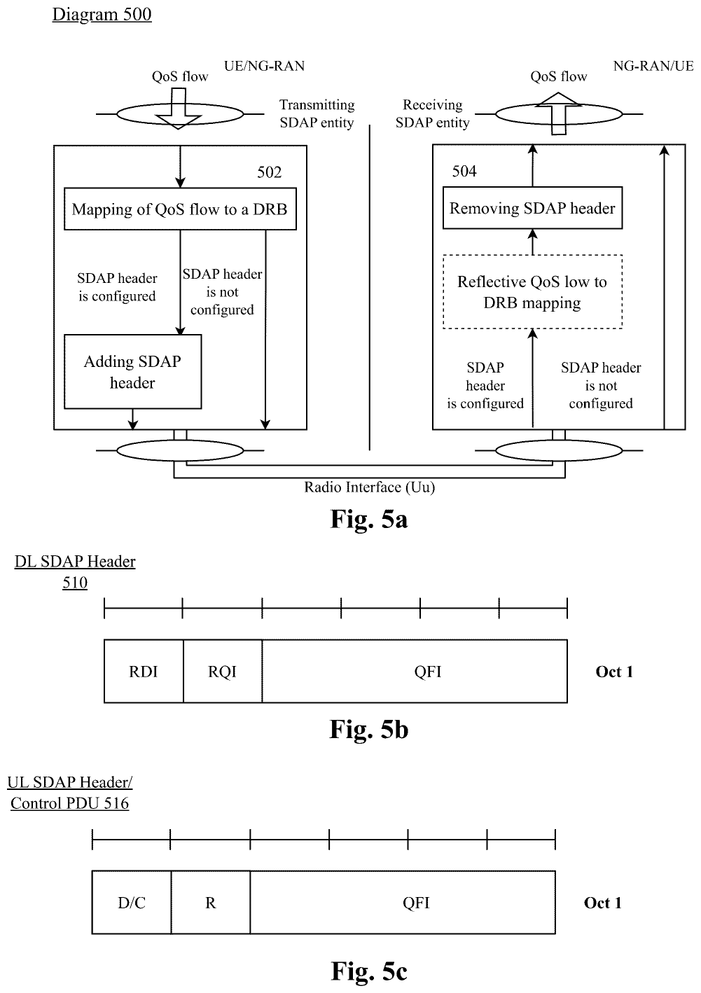

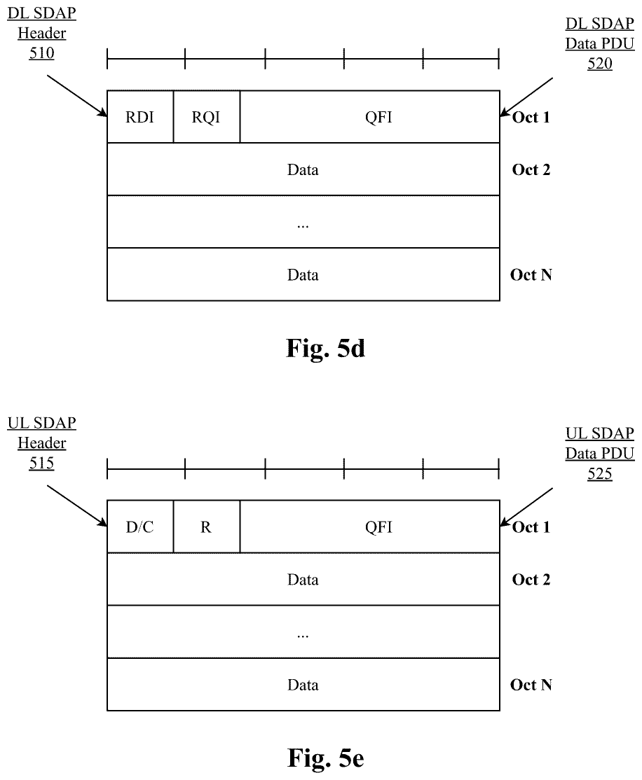

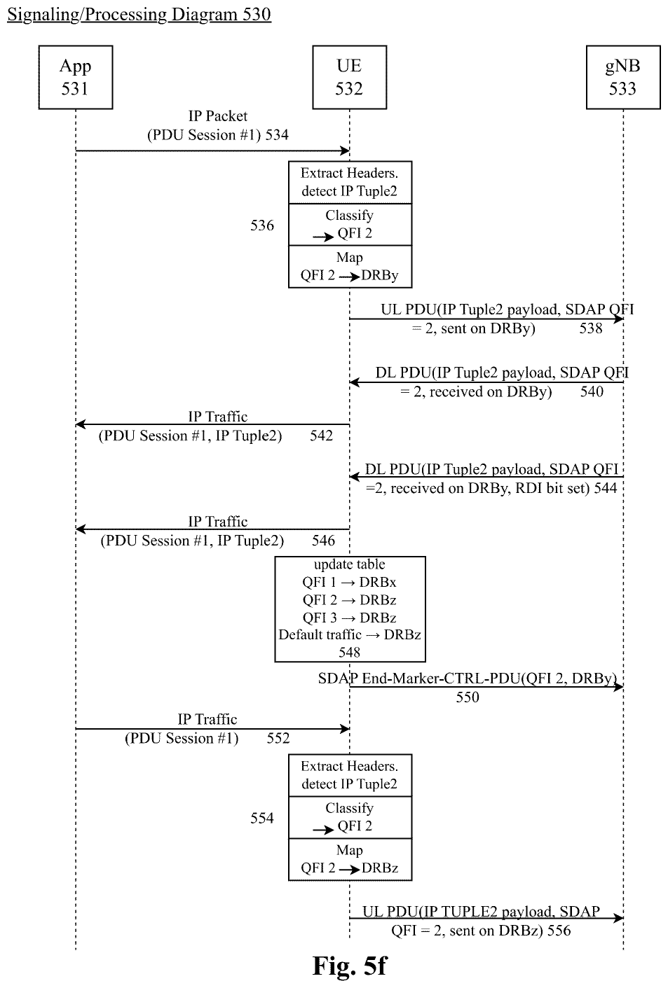

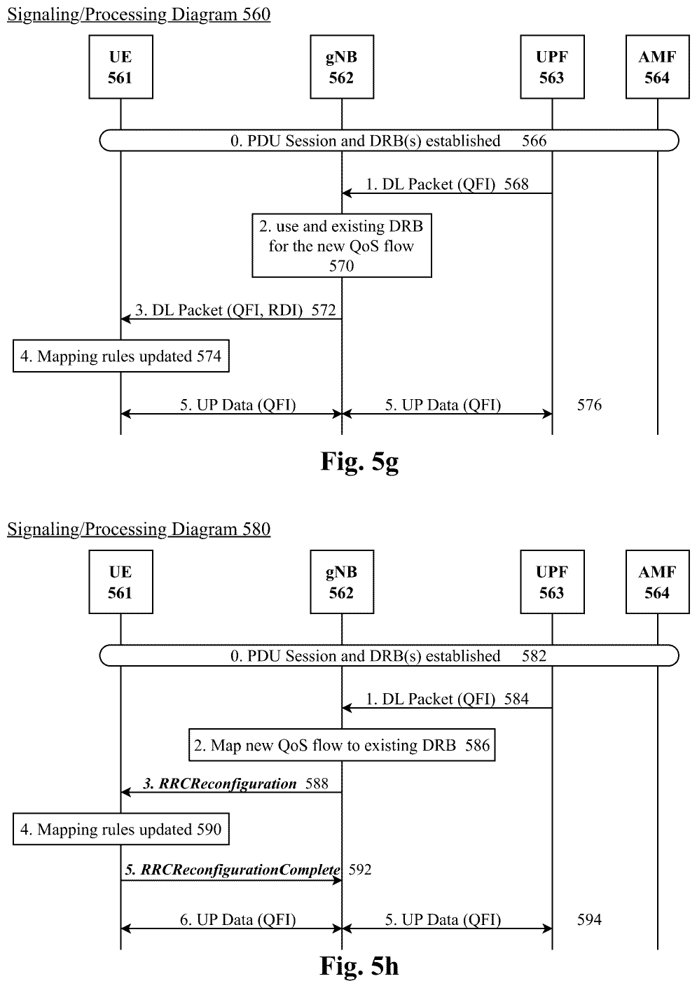

FIG. 5a shows a diagram 500 for QoS flow mapping at the SDAP layer according to one example. The diagram 500 includes a transmitting SDAP entity 502 (e.g., UE or gNB) receiving a QoS flow from higher layers, e.g., an application layer (for UL traffic at the UE) or the UPF (for DL traffic at the gNB), and mapping the QoS flow to a DRB based on the QoS flow mapping configuration. If the SDAP header is configured for the DRB, then the transmitting SDAP entity 502 adds the SDAP header prior to transmission over the Uu interface. The SDAP header is configured on a UL or DL DRB whenever reflective QoS is enabled and on a UL DRB when more than one QoS flow is mapped to the same DRB. A receiving SDAP entity 504 (e.g., UE or gNB) processes the packet and, if the SDAP header is configured, performs reflective QoS flow to DRB mapping, removes the SDAP header, and transmits the QoS flow to the UPF (for UL traffic at the gNB) or the 5GSM (for DL traffic at the UE).

On the DL, the gNB can add QFI (QoS Flow Indication) and ROI (Reflective QoS Indication) and/or RDI (Reflective QoS flow to DRB mapping Indication) in the DL SDAP header. The DL header is needed only if reflective mapping is used, which is optional for the gNB.

FIG. 5b shows a DL SDAP header 510 according to one example. The DL SDAP header 510 comprises an octet (one byte) with a QFI field (6 bits), an RQI bit and an RDI bit. The RQI bit can indicate the UE NAS to update its reflective mapping tables for service data flows (SDF) to QoS flow and the RDI bit indicates the UE AS to update its reflective mapping tables for QoS flows to DRBs.

On the UL, the UE can add QFI and D/C (data/control) in the UL SDAP header. The UL header is required when more than one QoS flow is mapped to a DRB (to indicate which QoS flow the DRB is carrying).

FIG. 5c shows a UL SDAP header 515 according to one example. The UL SDAP header 530 comprises an octet (one byte) with a QFI field (6 bits), a D/C bit and a reserved (R) bit. The D/C bit can indicate if the SDAP header carries an UL SDAP control PDU or UL SDAP data PDU. One bit of the UL SDAP header is not currently allocated for a parameter (a reserve (R) bit).

The UL SDAP data PDU can carry traffic with QFI marked to distinguish between multiple QoS flows mapped to a single DRB. The UL SDAP control PDU (e.g., SDAP header with no data) is used as a UL end-marker for a data flow (DRB) after the gNB has remapped a QoS flow to a different DRB and indicated/configured the new mapping rule.

TS 37.324 defines an UL SDAP end-marker control PDU. The SDAP end-marker control PDU is specific to SDAP and applies to QoS at the access stratum (AS) level only. There is no associated timer. An end-marker is required when the QoS flow to DRB mapping changes and is applicable to both reflective and RRC configured QoS mapping (see TS 38.300, TS 37.324, TS 38.331).

Reflective QoS (RQoS) at the AS level allows the network to use the RDI field to steer specific QoS flows from one DRB to another, e.g., to enhance the QoS handling in a window of time.

FIG. 5d shows a DL SDAP data PDU format 520 with a DL SDAP header 510 according to one example. When the RDI bit is set in the DL SDAP header 510, the UE receiving the PDU 520 can update its mapping tables for UL transmissions for the same QFI.

The UL packets belonging to the same QFI are steered by the UE to the same DRB on which the DL packet 520 is received. To complete the remapping, the UE also sends an SDAP end marker control PDU 515 as a last packet on the old DRB that was associated with the QFI. The UL control PDU 515 indicates to the network that no more packets belonging to the (remapped) QFI will be sent over the old DRB from that point onward.

FIG. 5e shows a UL SDAP data PDU format 525 with a UL SDAP header 515 according to one example. When the QFI is set in the UL SDAP header 515, the gNB can distinguish between multiple QoS flows mapped to a single DRB.

FIG. 5f shows an exemplary signaling and processing flow diagram 530 for reflective QoS flow to DRB mapping according to one example. The diagram 530 includes an application layer 531 exchanging IP packets with a UE 532 (lower UE layers) in a PDU session and the UE 532 exchanging PDUs with a gNB 533. The UE 532 is configured with QoS to DRB mapping rules including a first QFI (QFI 1) is mapped to DRBx, a second QFI (QFI 2) is mapped to DRBy, and a third QFI (QFI 3) is mapped to DRBz. In this example, DRBz is also the default bearer used when a QoS flow is not (yet) mapped to a DRB. Additionally, the UE 531 is configured for reflective QoS.

In 534, the UE 532 receives an IP packet for a PDU session (PDU session #1) from the application layer 531. In 536, the UE extracts the IP header(s), classifies the QoS flow of the packet (QFI 2), and maps the packet to a DRB (DRBy) according to the QoS to DRB mapping rules.

In 538, the UE 532 transmits an UL data PDU including the received IP packets to the gNB 533 with the UL SDAP header added. The UL PDU indicates QFI 2 and is sent on DRBy, according to the configured mapping rules. In 540, the UE 532 receives from the gNB 533 a first DL PDU with the DL SDAP header added, which similarly indicates QFI 2 and is sent on DRBy, according to the configured mapping rules. In 542, after processing, the UE 532 transmits the IP traffic from the first DL PDU to the application layer 531.

In 544, the UE 532 receives a second DL PDU from the gNB 533 with the DL SDAP header added. In this example, the second DL PDU indicates QFI 2 and the RDI bit is set. The second DL PDU is sent on DRBz, contrary to the current mapping rules for the UE. The RDI bit indicates to the UE 532 that a QoS flow to DRB remapping is to be performed, e.g., mapping the QoS flow of QFI 2 to the DRBz. In 546, after processing, the UE 532 transmits the IP traffic from the second DL PDU to the application layer 531.

In 548, the UE 532 updates its QoS flow to DRB mapping table so that QFI 2 is mapped to DRBz. In 550, the UE 532 replies to the gNB 533 with an SDAP end-marker control PDU indicating QFI 2 on DRBy, signifying that no further traffic for QFI 2 will be transmitted on DRBy.

In 552, the UE 532 receives UL IP traffic for PDU session #1 from the application layer 531. In 554, the UE 532 extracts the IP headers, classifies the QoS flow of the packet (QFI 2), and maps the packet to a DRB (DRBz) according to the updated QoS to DRB mapping rules. In 556, the UE 532 transmits an UL data PDU to the gNB 533 with the UL SDAP header. The header indicates QFI 2 and is sent on DRBz, according to the updated mapping.

In the examples discussed above, an existing QoS flow in an established PDU session is remapped from a first established DRB to a second established DRB. However, in some scenarios, a new QoS flow can be received in an established PDU session that does not have a mapping to a DRB. The gNB can map the new QoS to an existing or new DRB and signal the mapping to the UE using reflective QoS or explicit signaling.

FIG. 5g shows an exemplary signaling and processing flow diagram 560 for reflective QoS flow to DRB mapping for a new QoS flow according to one example. The diagram 560 includes a UE 561, a gNB 562, an instance of UPF 563, and an instance of AMF 564. Reflective QoS is configured for the UE.

In 566, the UE 561, gNB 562, UPF 563, and AMF 564 establish a PDU session and at least one DRB for the PDU session. The QoS parameters for a plurality of QoS flows are known from the PDU session establishment, but at least one QoS flow does not yet have an association to any DRB in the AS.

In 568, the gNB 562 receives a DL packet with a QFI value corresponding to a new QoS flow that does not yet have an association to a DRB. In 570, in this example, the gNB 562 determines to map the new QoS flow to an existing DRB. Alternatively, the gNB 562 can determine to map the new QoS flow to a new DRB. However, the gNB 562 would first need to establish the new DRB.

In 572, the UE 561 receives the DL packet from the gNB 562 with the DL SDAP header added, which indicates the new QFI and the RDI bit and is sent on the selected (existing) DRB. In 574, after processing (e.g., identifying the QFI, RDI, and DRB), the UE 561 updates its QoS flow to DRB mapping table so that the new QFI is mapped to the DRB on which the packet was received.

In 576, the user plane data for the new QoS flow can be exchanged between the UE 561 and the gNB 562 over the DRB according to the updated mapping rules and between the gNB 562 and the UPF 563 over the tunnel for the PDU session.

FIG. 5h shows an exemplary signaling and processing flow diagram 580 for explicit QoS flow to DRB mapping for a new QoS flow according to one example. Similar to the diagram 560 of FIG. 5f, the diagram 580 includes the UE 561, the gNB 562, the instance of UPF 563, and the instance of AMF 564.

In 582, the UE 561, gNB 562, UPF 563, and AMF 564 establish a PDU session and at least one DRB for the PDU session. Similar to above, the QoS parameters for a plurality of QoS flows are known from the PDU session establishment, but at least one QoS flow does not yet have an association to any DRB in the AS.

In 584, the gNB 562 receives a DL packet with a QFI value corresponding to a new QoS flow that does not yet have an association to a DRB. In 586, the gNB 562 determines to map the new QoS flow to an existing DRB.

In 588, the UE 561 receives an RRC reconfiguration message from the gNB 562 with the new QFI to DRB mapping rule. The gNB may also decide to update the DRB configuration in other ways, for example, if required to meet the QoS requirements for the new QoS flow. In 590, the UE 561 updates its QoS flow to DRB mapping table so that the new QFI is mapped to the DRB indicated by the gNB 562 (and any other DRB remapping configured by the gNB 562).

In 592, the UE 561 transmits an RRC reconfiguration complete message to the gNB 562. In 594, the user plane data for the new QoS flow can be exchanged between the UE 561 and the gNB 562 over the DRB according to the updated mapping rules and between the gNB 562 and the UPF 563 over the tunnel for the PDU session.

As described above, traffic that consists of multiple modalities (e.g., video, data, control, audio, etc.) often requires data transmission in multiple parallel QoS flows. Some of the traffic flows may possess high throughput and low latency requirements, while other traffic flows may have more relaxed requirements. Examples include XR or IIoT related use-cases. Depending on the mapping of QoS flows to logical channels, the queues (buffer) at the UE side can then fill up very quickly. In addition, delays on one DRB can lead to a degradation of user experience due to packets being processed outside of acceptable latency bounds.

For these reasons, it can be beneficial for the UE to influence the selection of DRB resources. As described above, according to current specification, only the gNB/network side can trigger an update of the QoS flow to DRB mapping by using explicit signaling or reflective QoS as described above. Thus, enhancements can be specified for a UE to initiate a QoS flow mapping or remapping, for example, to flexibly steer packets from one DRB to another, when necessary, utilizing the SDAP layer and enhancements to the UL SDAP headers. The extensions to the current QoS flow to DRB mapping mechanisms described herein may enable more dynamic QoS adaptation and related user plane enhancements. The exemplary embodiments also facilitate better treatment of groups of packets characterized by a PDU set or in ADU-based QoS.

It is noted that the current 5G QoS model does not allow the same QoS flow on multiple DRBs. The embodiments described herein assume that this aspect of the 5G QoS model remains unchanged, unless indicated otherwise below. Rather than mapping a single QoS flow to multiple DRBs, the exemplary embodiments describe the UE-initiated remapping of a QoS flow to a different DRB to further enhance the flexibility of QoS adaptation.

According to various aspects of these exemplary embodiments, techniques are described for UE-initiated reflective QoS through UL traffic. In some embodiments, the UE can request the network for an updated QFI to DRB mapping by indicating one or more parameters in the UL SDAP header in a UL transmission to the gNB. In other embodiments, the UE can use UL RRC signaling to request the updated mapping and optionally include additional information in the request, e.g., a buffer status. In some embodiments, the UE can control the QoS flow to DRB remapping by transmitting the request and expecting the network to accept the updated mapping automatically, e.g., without indicating a remapping in the DL. In addition, various implementation details are described including the use of prohibit and/or validity timers, capability aspects and configuration aspects.

In one aspect of these exemplary embodiments, the UE can request the network for an updated QFI to DRB mapping using a parameter (R bit) in the UL SDAP header, similar to the RDI mechanism used by the gNB on the DL. The UE can route a data packet with an existing QFI to a DRB different from the DRB currently mapped for the QoS flow. Alternatively, the UE can use dummy data or a UL SDAP control PDU.

Referring to FIG. 5c, the UL SDAP header 515 has one reserved (spare) bit (R). In one embodiment, the UE can use this reserved bit to signal a QoS flow to DRB mapping indication/request, similar to the RDI in DL. This is an in-band signaling method wherein the UE-initiated remapping request is transmitted on an existing DRB and is quickly processed at the gNB. It is noted that this repurposed reserve bit may be referred to as an RDI (Reflective QoS flow to DRB mapping Indication) bit or UL RDI bit herein, based on its similarity to the DL RDI bit included in the DL SDAP header. However, this repurposed field may be referred to by a different name (e.g., in specification) and the functionalities associated with the UL RDI bit described herein are similar but not identical to the specified DL RDI bit, as will be described below.

Upon reception of the UL SDAP header with the repurposed R-bit (RDI), the network identifies the QFI in the UL SDAP header and interprets this as a request from the UE to update the QoS flow to DRB mapping for this QFI. If the network honors the request, the QoS flow is mapped to the DRB on which the UL packet was received. It is noted that, in this embodiment, the QFI indicated in the UL SDAP header has a valid (existing) value in the PDU session. In other words, while the QFI value is not currently mapped to the DRB on which the SDAP PDU was received by the gNB, the QFI may be mapped to a different DRB, or may be established but currently unmapped.

After identifying the RDI request from the UE, the gNB can perform admission control for the QoS flow and decide whether to honor the UE request or not, to be described below. The actual (re-)mapping of the QoS flow to DRB may be performed by the gNB by either using the existing DL SDAP reflective QoS (RQoS) mechanism (e.g., by setting the RDI bit in the DL direction for this QFI and DRB) or by an explicit RRC reconfiguration.

Referring to FIG. 5e, the UL SDAP header 515 can be transmitted in a UL SDAP data PDU 525 including UL packet(s) for the QoS flow indicated in the QFI. The gNB can perform admission control of incoming QoS flows based on gNB implementation. In some scenarios, the gNB may be configured to check whether a QoS flow is received on the correct (currently mapped) DRB, and, in some configurations, discard the received packet. Thus, even if the request is honored by the gNB, the UL data packet carrying the request could be lost. Not only the request could be lost but the data as well (which may cause other issues related with in-sequence delivery, reordering, retransmission). In other examples, the gNB may not consider the packet as valid at all.

To address this issue, in one option, the gNB can be set so that the gNB does not discard the packet upon detection of a QFI not matching the current QoS flow to DRB mapping. In another option, the UE can transmit a dummy packet, which refers to transmission wherein the SDAP header is correct and valid but the payload indicates only dummy data (such as padding). Thus, if the gNB discards the payload due to the QFI not matching, there is no other related problem such as those described above. If the gNB performs some policing to check whether a QoS flow is received on the right DRB, the gNB may be configured to discard data received with an “incorrect” (or unmatched) QFI packet upon detection of a QFI not matching the current QoS flow to DRB mapping. To avoid a data loss while triggering a QoS flow (re-)mapping, the UE can include dummy data or padding (0x2B) in the UL data packet (as payload) that is used to carry the UE initiated reflective QoS request.

In another aspect of these exemplary embodiments, the UE can request the network for an updated QFI to DRB mapping without using the repurposed reserve bit in the UL SDAP header. The UE can simply route a data packet with an existing QFI (for a QoS flow) to a DRB different from the DRB previously used for the QoS flow, or use a dummy packet with the updated QFI set in the header.

In this option, the UL SDAP Data PDU does not modify the Reserved (UL RDI) bit. To signal a QoS flow to DRB Mapping Indication, the UE may simply indicate the QoS flow that is requested to be mapped/remapped with a valid QFI value in the SDAP header using a QFI value that is not mapped to the DRB over which the UL SDAP data packet is transmitted.

Upon reception of the UL SDAP header and identification that the QFI does not belong to the current DRB, the network can interpret this as a request from the UE to update the QoS flow to DRB mapping for this QFI to be mapped to the DRB where the packet was received on.

This option would require the gNB to process and compare every UL message for a match of the QFI according to a mapping rule, which could impact performance relative to the option described above wherein the UE sets the R-bit on relevant packets requiring a remapping.

In either of the aspects described above (request using R bit indication or not), the UE can request a QFI to DRB mapping for a new QFI that is not yet associated to any DRB in the access stratum (AS). The gNB can receive from the UE a first uplink packet associated with a QFI for which the QoS parameters are already known from the PDU session establishment, but that is not mapped to the DRB.

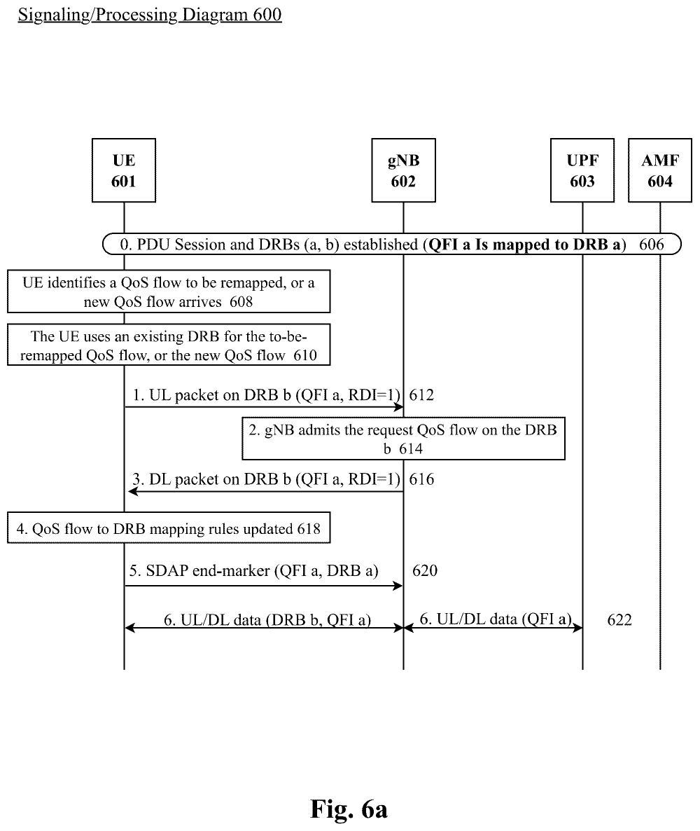

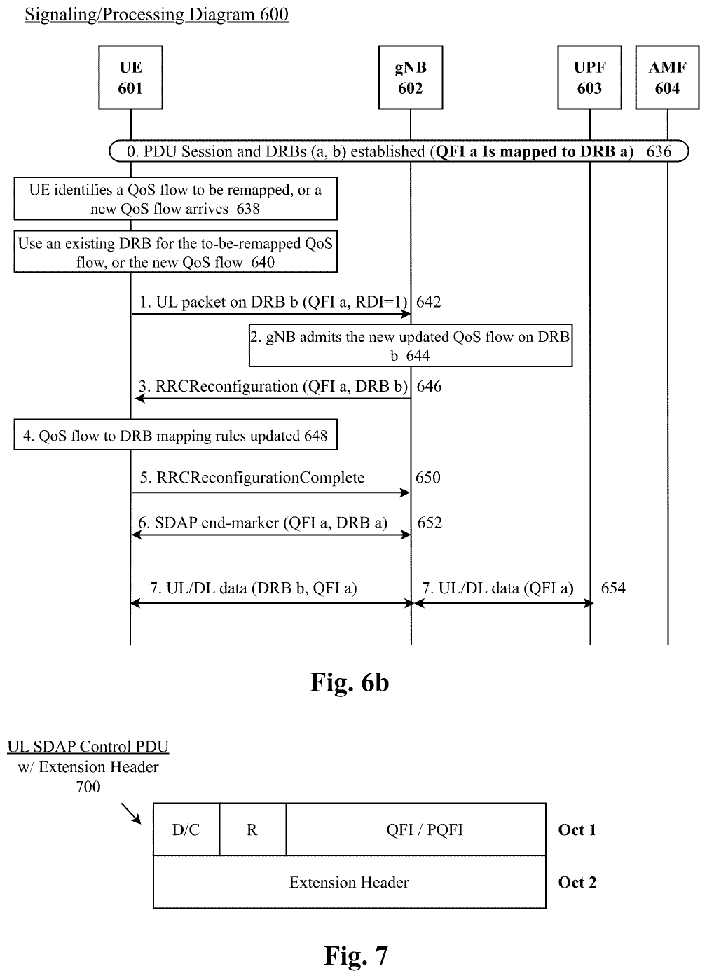

FIG. 6a shows a signaling and processing diagram 600 for a QoS flow to DRB mapping or remapping using reflective QoS based on a UE-initiated request according to various exemplary embodiments. The diagram 600 includes a UE 601, a gNB 602, an instance of UPF 603, and an instance of AMF 604, and reflective QoS is configured for the UE, similar to the diagram 560 of FIG. 5g.

In 606, the UE 601, gNB 602, UPF 603, and AMF 604 establish a PDU session and at least two DRBs (DRBs a and b) for the PDU session. A plurality of QoS flows (QFI) can also be established, however, only a first QoS flow (QFIa) is considered in the present example. In this example, QFIa is mapped to DRBa.

In 608, the UE 601 identifies that the existing QoS flow corresponding to QFIa should be remapped to a different DRB. The UE determination that the QoS flow should be remapped can be based on various considerations outside the scope of the present disclosure. In an alternative scenario, the UE 601 can receive a new QoS flow from an application and identify that the new QoS flow should be mapped to a DRB. In 610, the UE 601 identifies the DRB (DRBb) to which the existing QoS flow (QFIa) should be remapped. In the alternative scenario, the UE 601 identifies the DRB to which the new QoS flow should be mapped.

In 612, the UE 601 transmits a UL packet on DRBb to the gNB 602, the UL packet including an SDAP header identifying QFIa and indicating the RDI bit (e.g., the repurposed R bit of the existing UL SDAP header). The transmission of the UL packet on the DRB (DRBb) different from the currently mapped DRB (DRBa) for QFIa, with the RDI bit indicated, serves as a request to the network to remap the QFIa to the DRBb. It is noted that, in this example, the network still controls the actual remapping and the UE does not update its own mapping tables until the network initiates the remapping (in this example, using DL reflective QoS).

In 614, the gNB 602 processes the received UL packet and, in this example, admits the QoS flow (QFIa) on DRBb. In this example, the gNB 602 is configured with policy rules wherein the gNB 602 does not discard the UL packet in view of the mismatch between the DRB and the QoS flow. In any case, the RDI bit is set, which serves as a trigger. The gNB 602 admits the UL packet and interprets the mismatch between the DRB and QoS flow (QFI and RDI bit) as a UE-initiated remapping request. The gNB 602 further remaps the QoS flow to the new DRBb and, in the following steps, initiates the DL reflective QoS remapping process.

In 616, the UE 601 receives a DL packet from the gNB 602 with the DL SDAP header added, which indicates the QFIa and the RDI bit and is sent on the newly mapped DRBb. The RDI bit indicates that the QFIa is to be remapped to the DRBb used to transmit the DL packet.

In 618, after processing (e.g., identifying the QFI, RDI, and DRB), the UE 601 updates its QoS flow to DRB mapping table so that the QFIa is mapped to the DRBb on which the packet was received. In 620, the UE 601 transmits to the gNB 602 an UL SDAP control PDU indicating QFIa on DRBa, which serves as an end-marker for the QFIa on DRBa. The network interprets the UL SDAP control PDU as a confirmation/acknowledgement that no more data on QFIa will be transmitted on DRBa.

In 622, the user plane data for the QFIa can be exchanged between the UE 601 and the gNB 602 over the DRBb according to the updated mapping rules and between the gNB 602 and the UPF 603 over the tunnel for the PDU session.

FIG. 6b shows a signaling and processing diagram 630 for a QoS flow to DRB mapping or remapping using explicit RRC signaling based on a UE-initiated request according to various exemplary embodiments. The diagram 630 includes a UE 601, a gNB 602, an instance of UPF 603, and an instance of AMF 604, similar to the diagram 580 of FIG. 5g.

Steps 636-644 can be performed similarly to the steps 606-624 of the diagram 600 of FIG. 6a, wherein the PDU session, QoS flow(s) and DRBs are established for the UE 601, gNB 602, UPF 603, and AMF 604 (QFIa is mapped to DRBa), the UE 601 identifies that the existing QoS flow corresponding to QFIa should be remapped to DRBb, the UE 601 transmits a UL packet on DRBb to the gNB 602 including an SDAP header identifying QFIa and indicating the RDI bit, and the gNB 602 processes the received UL packet and, in accordance with gNB policy rules, admits the QoS flow on DRBb and interprets the mismatch as a UE-initiated remapping request.

In 646, the UE 601 receives an RRC reconfiguration from the gNB 602 including updated QoS flow to DRB mapping rules. In this example, the RRC reconfiguration indicates that QFIa should be remapped to DRBb. In 648, the UE 601 updates its QoS flow to DRB mapping table so that the OFIa is mapped to the DRBb. In 650, the UE 601 transmits to the gNB 602 an RRC reconfiguration complete.

In 652, the UE 601 transmits a UL SDAP control PDU indicating QFIa on DRBa, which serves as an end-marker for the QFIa on DRBa. The network interprets the UL SDAP control PDU as a confirmation/acknowledgement that no more data on QFIa will be transmitted on DRBa. In 654, the user plane data for the QFIa can be exchanged between the UE 601 and the gNB 602 over the DRBb according to the updated mapping rules and between the gNB 602 and the UPF 603 over the tunnel for the PDU session.

According to another aspect of these exemplary embodiments, the UE can use an UL SDAP control PDU to request the network for an updated QFI to DRB mapping. This aspect is similar to those described above and is based on the use of the UL SDAP header. However, in these embodiments, the UE-initiated remapping request comprises the transmission of a UL SDAP header only (a UL SDAP control PDU), without any UL data included therewith.

Referring to FIG. 5c, the UL SDAP control PDU comprises a QFI/PQFI field (6 bits), an R bit and a D/C bit in an octet. According to the present embodiment, the UE uses the SDAP Control PDU with a QFI set to a valid value and R bit set to 1 to indicate a UE-initiated reflective QoS request to the network.

The R bit distinguishes the SDAP control PDU for the UE-initiated remapping request from an end-marker control PDU. The SDAP Control PDU is sent on the DRB on which the QoS flow is requested to be mapped to. The network can decide whether to honor the request or not, and initiate the remapping via RQoS or explicit RRC, similar to the aspects described above.

By using the UL SDAP control PDU, the UE can request a (re-)mapping of a QoS flow without re-routing data from one DRB queue to another DRB queue, and/or without including a dummy data packet to prevent the loss of data, as described above.

In another embodiment, the SDAP control PDU includes an extension header in a second octet. The extension header can be defined when the R bit is set to 1 and can carry different kinds of information described below.

FIG. 7 shows a UL SDAP control PDU 700 with an extension header according to various exemplary embodiments. The UL SDAP control PDU 700 comprises a first octet (one byte) with a QFI field (6 bits), a D/C bit and a reserved (R) bit and a second octet (one byte) comprising the extension header.

In some embodiments, the extension header can carry additional information about the UE-initiated request, e.g., a buffer status for one or more QoS flows. The extension header can also define additional SDAP control PDU types for future enhancements. Additional parameters can also be defined. The exact format of the extension header can be defined in specification and may also contain more than one byte. Similar to the embodiments described above, the SDAP control PDU with extension header can be sent on the DRB on which the QoS flow is requested to be mapped, and the network can decide whether to honor the request or not.

Using the extension header, the UE may send a buffer status per QoS flow as additional information, along with the SDAP control PDU that is requesting a remapping. This provides more information to the network to follow or not follow the UE request. In another option, the UE may simply send a buffer status. This however requires that the UE has to have a notion of a buffer status per QoS flow (e.g., at SDAP), currently it is per DRB or LCH.

As described above, there may be scenarios wherein the network configures the gNB with policy rules that could affect the UE-initiated remapping process. For example, the gNB could be configured to discard packets for a QFI that is transmitted over a DRB that does not match the gNB mapping tables.

According to further aspects of these exemplary embodiments, the gNB can configure the UE to send the UE-initiated RQoS requests and/or QoS remapping requests. In this way, there is no possibility that the gNB receives something it does not expect.

Additionally, the UE may indicate its ability to perform the UE-initiated remapping request in a UE capability. Both the UE capability as well as the network configuration may also indicate a specific option that is supported, if multiple options are available, such as the previously described aspects and further aspects to be described below.

The UE initiated QoS flow to DRB mapping can be a new sub-feature signaled in a new UE capability. The network may activate the feature via a RRC configuration. To implement these features, the gNB can configure the SDAP UL header on supported DRBs. The gNB can select only a subset of configured DRBs to be eligible. This could be configurable. In another embodiment, PQFI may be used instead of QFI (e.g., over NR sidelink communication.

If the DRB to which the packet is rerouted (e.g., LCH2) has a lower QoS than LCH1 then there is a chance for the packet to get lost. Thus, this option should be used under specific circumstances in consideration of this risk. Alternatively, the second DRB can be required to be defined as one that needs to have better QoS.

In some scenarios, the UE may not receive a response from the network for a QoS-to-DRB remapping request. For example, in RLC UM, the R-bit can get lost. If the network does not update QFI to DRB mapping within a predefined ‘wait’ period, the UE will move the QFI (i.e., packets with an unmatched QFI) back to the original DRB. A UE may send multiple requests on consecutive packets or repeat the request after some time. If the network does not honor the UE initiated request (or multiple UE-initiated requests) within the predetermined wait period, the UE may be disallowed to repeat the request within a specified time (e.g., controlled by a prohibit timer).

Additionally, a UE-initiated request for QoS to DRB remapping may be associated with a validity time where the QoS flow to DRB mapping change is of temporary nature. After a (specified or configured) period of time, the original QoS flow to DRB mapping can be restored automatically.

In still another aspect of these exemplary embodiments, the UE can directly request a QoS mapping update through UL RRC signaling. Instead of using the SDAP layer to initiate the UE request, as described above, the UE may use a more direct indication of what the UE needs. Upon reception of the UE request, the gNB can respond with an RRCReconfiguration to explicitly remap the DRBs similar to the embodiments described above.

The UE request may be indicated though any one of the options below. In all options, the UE indicates a new parameter or a new information element with at least an indication for one or more specific QoS flows requested for remapping.

In one option, the UE request may be included in an UEAssistanceInformation message. In another option, the use of the ULInformationTransfer message may be extended to carry such additional information. In further options, the UE could utilize an existing RRC uplink message to include a parameter or IE, or a new RRC uplink message may be created for this purpose. In still other options, a new MAC CE can be used.

One advantage of this approach is that the UE request may contain additional information compared to a single bit such as RDI in the SDAP-related methods described above. Moreover, the actual parameters are extensible through a simple RRC parameter update. A UE could even suggest a full QoS flow to DRB mapping along with additional QoS information from the application. A disadvantage is that a RRC method is slower than an in-band method via SDAP.

Similar to above for SDAP, the UE can report a capability for UL RRC-requested QoS flow to DRB mapping and can be configured by the network with the feature. The request can be associated with a prohibit timer and/or a validity timer, as described above.

In still another aspect of these exemplary embodiments, for a UE-initiated request that is sent according to the previous embodiments, (e.g., using a UL SDAP data or control PDU) rather than waiting for a network response (DL reflective QoS or RRC reconfiguration), the UE may simply send a new QFI and expect the network to automatically accept that as an updated mapping. To retain a degree of control over network resources, the network may allocate a specific subset of QoS flows or DRBs for such a purpose. In a further option, the participating DRBs and QoS flows may be associated with a specific purpose, a common set of QoS characteristics, a PDU session, etc.

It is then left to the UE to map such a QFI to a DRB (also out of a set of DRBs), that is, the UE is in control to map QoS flows to (a subset of) DRBs. Moreover, the UE and the network may adhere to the following extra conditions. The UE can ensure that one QoS flow is always mapped to one DRB and only one DRB. The UE can reconfigure the UL and/or DL QoS flow to DRB mapping tables and use UL RQoS.

The gNB updates its QoS flow to DRB mapping rules and may optionally send an SDAP end-marker control PDU (or another message) as an Acknowledgement. In another example, a new DL SDAP control PDU can be created, or a DL SDAP data PDU with a special format could be used.

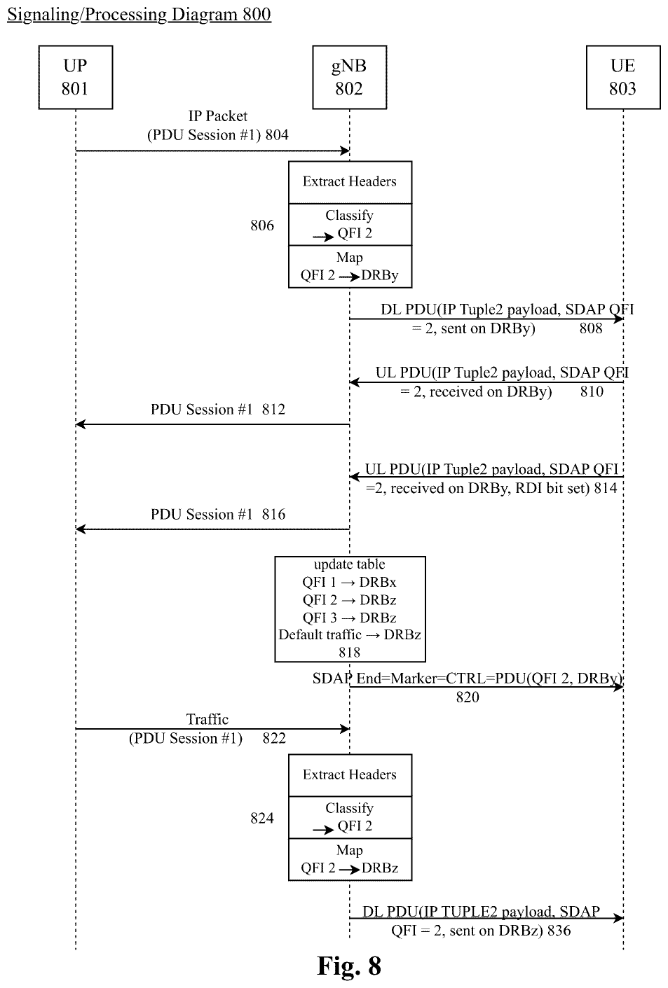

FIG. 8 shows an exemplary signaling and processing flow diagram 800 for UE-controlled QoS flow to DRB mapping according to various exemplary embodiments. The diagram 800 includes an instance of the UPF 801 exchanging service data units (SDUs) with a gNB 802 in a PDU session and the gNB 802 exchanging PDUs with a UE 803. The gNB 802 has a shadow mapping (according to gNB implementation) of the QoS to DRB mapping rules configured for the UE 803, including a first QFI (QFI 1) is mapped to DRBx, a second QFI (QFI 2) is mapped to DRBy, and a third QFI (QFI 3) is mapped to DRBz. In this example, DRBz is also the default bearer used when a QoS flow is not (yet) mapped to a DRB. Additionally, the UE 803 and gNB 802 are configured for UE-controlled QoS flow to DRB mapping feature(s).

In 804, the gNB 802 receives a packet for a PDU session (PDU session #1) from the UPF 801. In 806, the gNB 802 extracts the header(s), classifies the QoS flow of the packet (QFI 2), and maps the packet to a DRB (DRBy) according to the QoS to DRB mapping rules.

In 808, the gNB 802 transmits a DL data PDU including the received packets to the UE 803 with the DL SDAP header added. The DL PDU indicates QFI 2 and is sent on DRBy, according to the configured mapping rules. In 810, the gNB 802 receives from the UE 803 a first UL PDU with the UL SDAP header added, which similarly indicates QFI 2 and is sent on DRBy, according to the configured mapping rules. In 812, after processing, the gNB 802 transmits the traffic from the first UL PDU to the UPF 801 in a service data flow (SDF).

In 814, the gNB 802 receives a second UL PDU from the UE 803 with the UL SDAP header added. In this example, the second UL PDU indicates QFI 2 and the RDI bit is set. The second UL PDU is sent on DRBz, contrary to the current mapping rules. The RDI bit indicates to the gNB 802 that a QoS flow to DRB remapping is to be performed, e.g., mapping the QoS flow of QFI 2 to the DRBz. The second UL PDU could also be a control PDU. In 816, after processing, the gNB 802 transmits the traffic from the second UL PDU to the UPF 801.

In 818, the gNB 802 updates its shadow QoS flow to DRB mapping table so that QFI 2 is mapped to DRBz for both the UL and DL mapping tables. In 820, the gNB 802 replies to the UE 803 with a DL SDAP end-marker control PDU indicating QFI 2 on DRBy, signifying that no further traffic for QFI 2 will be transmitted on DRBy. The UE 803 updates its mapping tables as well.

In 822, the gNB 802 receives DL traffic for PDU session #1 from the UPF 801. In 824, the gNB 802 extracts the headers, classifies the QoS flow of the packet (QFI 2), and maps the packet to a DRB (DRBz) according to the updated QoS to DRB mapping rules. In 826, the gNB 802 transmits a DL data PDU to the UE 803 with the DL SDAP header. The header indicates QFI 2 and is sent on DRBz, according to the updated mapping.

Similar to the embodiments described above, the updated mapping may be of temporary nature (i.e., valid for a period of time), or permanent. Along with this approach, the UE can utilize foreground/background traffic and put some background traffic on a best effort bearer (or another bearer with lower QoS) much more dynamically. This solution allows for fast remapping (distribution) of QoS flows to DRBs according to changing demands, buffer status, and application layer influence. Optionally, to make this solution more efficient, the network restriction that one QoS flow can be mapped to one and only one DRB may be lifted.

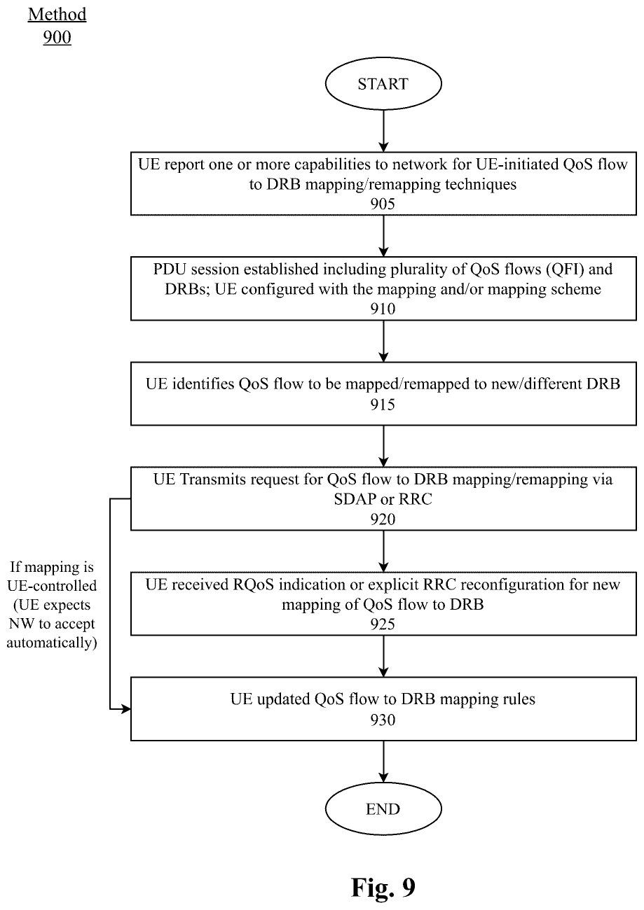

FIG. 9 shows a method 900 for a UE-initiated QoS flow to DRB mapping/remapping according to various exemplary embodiments.

In 905, the UE reports a capability for one or more UE-initiated QoS flow to DRB mapping/remapping techniques (or features/sub-features). As described above, the capability can relate to UE transmission of the mapping/remapping request via an UL SDAP data PDU (with actual UL data or with dummy data; with the R bit (UL RDI) indicated or not), an UL SDAP control PDU (with or without an extension header), or UL RRC signaling. The capability can also relate to UE-controlled mapping/remapping, where the UE (re-)maps a QFI to a DRB and expects the network to automatically accept the updated mapping without requiring any DL remapping techniques (DL RQoS or explicit DL RRC signaling). It is noted that, in some embodiments, the new UE capability is not required to implement the UE-initiated remapping techniques.

In 910, a PDU session including a plurality of QoS flows and DRBs is established for the UE and the network/gNB (and core network entities including the UPF and the AMF). The UE receives an explicit mapping from the network including, at least, a QoS flow to DRB mapping for one or more DL QoS flows. In some embodiments, the UE further receives an explicit mapping including a QoS flow to DRB mapping for one or more UL QoS flows, while in other embodiments, reflective QoS is used for the UE to determine the UL QoS to DRB mapping table.

In some embodiments, the network may allocate a specific subset of QoS flows or DRBs for UE-requested or UE-controlled remapping. The UL SDAP header can be configured on supported DRBs.

The UE can also receive an RRC configuration for reflective QoS or via explicit signaling for determining a mapping for UL data flows. The RRC configuration can activate one or more of the UE-initiated QoS flow to DRB (re-)mapping techniques (or features/sub-features). The features/sub-features can be activated for all DRBs or for a subset of DRBs.

In 915, the UE identifies at least one UL QoS flow to be mapped or remapped to a new DRB. The UE may make this determination based on a variety of different factors. In one example, a new QoS flow is received from the application/upper layer(s) that is not yet mapped to a DRB. In another example, changing demands, buffer status, or application layer influence can indicate to the UE that a UL QoS flow should be remapped to a different DRB, e.g., to satisfy QoS requirements for a data flow.

In 920, the UE transmits a request for a UL QoS flow to DRB mapping or remapping based on the UE assessment performed in 915. In some embodiments, the request can be transmitted by a UL SDAP data PDU including a UL SDAP header indicating a QFI for the QoS flow to be remapped. In one option, the data PDU can include dummy data or padding. In some embodiments, the UL SDAP header can further indicate an RDI bit (the “R” or reserved bit in existing UL SDAP header). In other embodiments, the request can be transmitted by a UL SDAP control PDU (UL SDAP header without data) indicating the OFI and the RDI bit to distinguish the SDAP control PDU for DRB remapping from an SDAP end-marker control PDU. In still other embodiments, the UL SDAP control PDU can have an extension header carrying additional information/parameters, e.g., a buffer status for a QoS flow.

In other embodiments, the request can be transmitted by UL RRC signaling, e.g., in UE assistance information (UAI), an existing UL RRC message format, or a new UL RRC message. Although this method would be slower than an in-band SDAP method, additional information can be carried via RRC relative to the single RDI (reserve) bit in the SDAP header.

In some embodiments, the UE may not receive a response from the network for a QoS-to-DRB remapping request, and may send multiple requests on consecutive packets or repeat the request after some time. If the network does not honor the UE initiated request (or multiple UE-initiated requests) within a predetermined wait period, the UE may be disallowed to repeat the request within a specified time (e.g., controlled by a prohibit timer). Additionally, the UE-initiated request for QoS to DRB remapping may be associated with a validity time where the QoS flow to DRB mapping change is of temporary nature. After a (specified) period of time, the original QoS flow to DRB mapping can be restored automatically.

In other embodiments, the UE can expect the network to automatically accept the updated mapping without requiring any DL remapping techniques (DL RQoS or explicit DL RRC signaling). The UE may, in some embodiments, wait for an acknowledgement, e.g., a DL SDAP end-marker or some other message, from the network prior to updating its UL mapping tables.

If the UE is not configured for UE-controlled remapping (where the remapping request is automatically accepted by the network), then the UE waits for a network mapping/remapping configuration/indication from the network, e.g., via reflective QoS or explicit RRC signaling. In some scenarios, the UE may not receive a timely response from the network for the request. In some embodiments, the UE may transmit multiple requests until a response is received. If a response is not received within some predetermined duration (e.g., prohibit timer), the UE may be disallowed to repeat the request for some specified time.

When the UL SDAP header is used in a UL SDAP PDU, The gNB performs admission control for the received packet, interprets the parameters (e.g., RDI bit and QFI) in the UL header as a request for a remapping and determines whether to honor the request. In some scenarios, the gNB can be configured to discard the packet. In other embodiments, an UL RRC request is used. The gNB can determine whether to configure the requested QoS mapping based on gNB implementation. In some embodiments, the request includes additional information (e.g., buffer status information per QoS/DRB) and the gNB can consider this additional information when deciding whether to remap the UL QoS flows in accordance with the request.

If the request is received in a UE-controlled QoS remapping arrangement (e.g., on a DRB configured for UE-controlled QoS remapping), the gNB can automatically update its mapping tables and no further communications are needed to exchange data on the remapped DRB.

In 925, the UE receives either a reflective QoS indication or an explicit RRC reconfiguration from the network. As described above, if RQoS is used, the gNB transmits a DL packet with an SDAP header indicating QFI with the RDI bit set on the DRB on which the QFI is to be mapped. If explicit RRC signaling is used, the gNB transmits a DL RRC configuration including the new mapping. In some embodiments, the UE may receive an RRC configuration for multiple new/different QoS flow to DRB mappings.

In 930, the UE updates its QoS flow to DRB mapping rules. As described above, this could be based on explicit RRC signaling, RQoS, the transmission of a UE-controlled remapping, or the receipt of an acknowledgement of the UE-controlled remapping request.

In some embodiments, the UE further transmits an SDAP end-marker control PDU on the original DRB to mark the end of the QoS flow on that DRB.

In some embodiments, the updated mapping is of a temporary nature and is associated with a validity timer, after which the original mapping is restored.

### EXAMPLES

In a first example, a method performed by a user equipment (UE), comprising establishing a protocol data unit (PDU) session including one or more quality of service (QoS) flows and multiple data radio bearers (DRB) for communications with a network, receiving or determining an initial mapping table for a QoS flow to DRB mapping based on a network configuration of mapping parameters, determining a first QoS flow to map or remap to a new or different DRB and transmitting a request to the network for the first QoS flow to be mapped or remapped to the new or different DRB.

In a second example, the method of the first example, wherein the request comprises an uplink (UL) service data adaptation protocol (SDAP) PDU including a header indicating a first QoS flow identifier (QFI) corresponding to the first QoS flow, wherein the request is transmitted over the new or different DRB.

In a third example, the method of the second example, wherein the UL SDAP PDU is a data PDU including one or more packets marked with the first QFI.

In a fourth example, the method of the second example, wherein the UL SDAP PDU is a data PDU including padding.

In a fifth example, the method of the second example, wherein the header further indicates the request using a reserve bit in the header.

In a sixth example, the method of the first example, further comprising receiving a downlink (DL) RRC reconfiguration or DL reflective QoS (RQoS) indication mapping or remapping the first QoS flow to the new or different DRB in accordance with the request and updating the initial mapping table to an updated mapping table including the first QoS flow mapped to the new or different DRB.

In a seventh example, the method of the first example, wherein, upon transmitting the request, the UE assumes the network will automatically update network mapping tables in accordance with the request.

In an eighth example, the method of the seventh example, further comprising, after the request is transmitted, and without receiving a downlink (DL) mapping or remapping of the first QoS flow, updating the initial mapping table to an updated mapping table including the first QoS flow mapped to the new or different DRB.

In a ninth example, the method of the eighth example, further comprising receiving an acknowledgment from the network of the mapping or remapping of the first QoS flow.

In a tenth example, the method of the eighth example, wherein the acknowledgment comprises a DL service data adaptation protocol (SDAP) control PDU.

In an eleventh example, the method of the first example, further comprising receiving, from an application layer, one or more uplink (UL) packets marked with the first QFI, wherein the first QFI is a new QFI that is not yet mapped to any of the multiple DRBs and transmitting the request to the network for the first QoS flow to be mapped to the new DRB.

In a twelfth example, the method of the first example, further comprising transmitting further requests to the network for the first QoS flow to be mapped or remapped when a response is not received by the network.

In a thirteenth example, the method of the twelfth example, wherein, if the response is not received by the network after a predetermined duration from the transmission of the request, the UE is prohibited from transmitting additional requests until a timer has elapsed.

In a fourteenth example, the method of the first example, wherein the request is associated with a duration of validity, after which the initial mapping table is restored.

In a fifteenth example, the method of the first example, further comprising reporting a UE capability for one or more UE-initiated QoS flow to DRB mapping techniques or features and receiving a radio resource control (RRC) configuration activating a first UE-initiated QoS flow to DRB mapping feature.

In a sixteenth example, the method of the fifteenth example, wherein the feature is configured for only a subset of the multiple established DRBs.

In a seventeenth example, the method of the first example, wherein the UE determines to map or remap the first QoS flow to the new or different DRB based on current or expected UL traffic conditions, a buffer status, or higher layer influence.

In an eighteenth example, the method of the first example, wherein the request comprises an uplink (UL) service data adaptation protocol (SDAP) PDU including a header indicating a first PC5 QoS flow identifier (PQFI) corresponding to the first QoS flow.

In a nineteenth example, a processor configured to perform any of the methods of the first through eighteenth examples.

In a twentieth example, a user equipment (UE) comprising a transceiver configured to communicate with a network and a processor communicatively coupled to the transceiver and configured to perform any of the methods of the first through eighteenth examples.

In a twenty first example, a method is performed by a base station, comprising establishing a protocol data unit (PDU) session including one or more quality of service (QoS) flows and multiple data radio bearers (DRB) for communications with a user equipment (UE), indicating mapping parameters for the UE to determine an initial mapping table for a QoS flow to DRB mapping, receiving a request from the UE for a first QoS flow to be mapped or remapped to a new or different DRB, determining whether to honor the request and follow the mapping or remapping of the first QoS flow to the new or different DRB based on policy rules configured for the base station.

In a twenty second example, the method of the twenty first example, wherein the request comprises an uplink (UL) service data adaptation protocol (SDAP) PDU including a header indicating a first QoS flow identifier (QFI) corresponding to the first QoS flow, wherein the request is transmitted over the new or different DRB, wherein the base station, based on the policy rules, interprets the header as comprising the request for mapping the first QoS flow to the new or different DRB.

In a twenty third example, the method of the twenty second example, wherein the UL SDAP PDU is a data PDU including one or more packets marked with the first QFI.

In a twenty fourth example, the method of the twenty second example, wherein the UL SDAP PDU is a data PDU including padding, wherein the base station discards the data PDU after processing the request.

In a twenty fifth example, the method of the twenty second example, wherein the header further indicates the request using a reserve bit in the header.

In a twenty sixth example, the method of the twenty first example, further comprising transmitting a downlink (DL) RRC reconfiguration or DL reflective QoS (RQoS) indication mapping or remapping the first QoS flow to the new or different DRB in accordance with the request.

In a twenty seventh example, the method of the twenty first example, wherein, upon transmitting the request, the UE assumes the base station will automatically update network mapping tables in accordance with the request.

In a twenty eighth example, the method of the twenty seventh example, further comprising transmitting an acknowledgment to the UE of the mapping or remapping of the first QoS flow.

In a twenty ninth example, the method of the twenty eighth example, wherein the acknowledgment comprises a DL service data adaptation protocol (SDAP) control PDU.

In a thirtieth example, the method of the twenty first example, wherein the request is associated with a duration of validity, after which the initial mapping table is restored.

In a thirty first example, the method of the twenty first example, further comprising receiving a UE capability report for one or more UE-initiated QoS flow to DRB mapping techniques or features and transmitting a radio resource control (RRC) configuration activating a first UE-initiated QoS flow to DRB mapping feature.

In a thirty second example, the method of the thirty first example, wherein the feature is configured for only a subset of the multiple established DRBs.

In a thirty third example, the method of the twenty first example, wherein the request comprises an uplink (UL) service data adaptation protocol (SDAP) PDU including a header indicating a first PC5 QoS flow identifier (PQFI) corresponding to the first QoS flow.

In a thirty fourth example, a processor configured to perform any of the methods of the twenty first through thirty third examples.

In an thirty fifth example, a base station comprising a transceiver configured to communicate with a user equipment (UE) and a processor communicatively coupled to the transceiver and configured to perform any of the methods of the twenty first through thirty third examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, a real-time operating system (RTOS), etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
establish a protocol data unit (PDU) session including one or more quality of service (QoS) flows and multiple data radio bearers (DRB) for communications with a network;
decode, from signaling received from the network, or determine an initial mapping table for a QoS flow to DRB mapping based on a network configuration of mapping parameters;
determine a first QoS flow to map or remap to a new or different DRB; and
configure transceiver circuitry to transmit a request to the network for the first QoS flow to be mapped or remapped to the new or different DRB.

2. The apparatus of claim 1, wherein the request comprises an uplink (UL) service data adaptation protocol (SDAP) PDU including a header indicating a first QoS flow identifier (QFI) corresponding to the first QoS flow,
wherein the request is transmitted over the new or different DRB.

3. The apparatus of claim 2, wherein the UL SDAP PDU is a data PDU including one or more packets marked with the first OFI.

4. The apparatus of claim 2, wherein the UL SDAP PDU is a data PDU including padding.

5. The apparatus of claim 2, wherein the header further indicates the request using a reserve bit in the header.

6. The apparatus of claim 1, wherein the processing circuitry is further configured to:
decode, from signaling received from the network, a downlink (DL) RRC reconfiguration or DL reflective QoS (RQoS) indication mapping or remapping the first QoS flow to the new or different DRB in accordance with the request; and
update the initial mapping table to an updated mapping table including the first QoS flow mapped to the new or different DRB.

7. The apparatus of claim 1, wherein, upon transmitting the request, the UE assumes the network will automatically update network mapping tables in accordance with the request.

8. The apparatus of claim 7, wherein the processing circuitry is further configured to:
after the request is transmitted, and without receiving a downlink (DL) mapping or remapping of the first QoS flow, update the initial mapping table to an updated mapping table including the first QoS flow mapped to the new or different DRB.

9. The apparatus of claim 8, wherein the processing circuitry is further configured to:
decode, from signaling received from the network, an acknowledgment of the mapping or remapping of the first QoS flow.

10. The apparatus of claim 9, wherein the acknowledgment comprises a DL service data adaptation protocol (SDAP) control PDU.

11. The apparatus of claim 1, wherein the processing circuitry is further configured to:
receive, from an application layer, one or more uplink (UL) packets marked with the first QFI, wherein the first QFI is a new QFI that is not yet mapped to any of the multiple DRBs; and
configure transceiver circuitry to transmit the request to the network for the first QoS flow to be mapped to the new DRB.

12. The apparatus of claim 1, wherein the processing circuitry is further configured to:
configure transceiver circuitry to transmit further requests to the network for the first QoS flow to be mapped or remapped when a response is not received by the network.

13. The apparatus of claim 12, wherein, if the response is not received by the network after a predetermined duration from the transmission of the request, the UE is prohibited from transmitting additional requests until a timer has elapsed.

14. The apparatus of claim 1, wherein the request is associated with a duration of validity, after which the initial mapping table is restored.

15. The apparatus of claim 1, wherein the processing circuitry is further configured to:
configure transceiver circuitry to transmit a UE capability for one or more UE-initiated QoS flow to DRB mapping techniques or features; and
decode, from signaling received from the network, a radio resource control (RRC) configuration activating a first UE-initiated QoS flow to DRB mapping feature.

16. The apparatus of claim 15, wherein the feature is configured for only a subset of the multiple established DRBs.

17. The apparatus of claim 1, wherein the UE determines to map or remap the first QoS flow to the new or different DRB based on current or expected UL traffic conditions, a buffer status, or higher layer influence.

18. An apparatus of a base station, the apparatus comprising processing circuitry configured to:
establish a protocol data unit (PDU) session including one or more quality of service (QoS) flows and multiple data radio bearers (DRB) for communications with a user equipment (UE);
indicate mapping parameters for the UE to determine an initial mapping table for a QoS flow to DRB mapping;
decode, from signaling received from the UE, a request from the UE for a first QoS flow to be mapped or remapped to a new or different DRB; and
determine whether to honor the request and follow the mapping or remapping of the first QoS flow to the new or different DRB based on policy rules configured for the base station.

19. The apparatus of claim 18, wherein, upon transmitting the request, the UE assumes the base station will automatically update network mapping tables in accordance with the request.

20. The apparatus of claim 19, wherein the processing circuitry is further configured to:
configure transceiver circuitry to transmit an acknowledgment to the UE of the mapping or remapping of the first QoS flow.
